(19) United States
(12) Patent Application Publication
(10) Pub. No.: US 2018/0073502 A1
(43) Pub. Date: Mar. 15, 2018

(54) RECIPROCATING PISTON PUMP AND METHOD OF MANUFACTURE

(71) Applicant: Bio-Chem Fluidics, Inc., Boonton, NJ (US)

(72) Inventors: Henry Huang, Edison, NJ (US); Razvan Bulugioiu, Mountain Lakes, NJ (US); William Easterbrook, Clinton, NJ (US)

(73) Assignee: Bio-Chem Fluidics, Inc., Boonton, NJ (US)

(21) Appl. No.: 15/692,930

(22) Filed: Aug. 31, 2017

Related U.S. Application Data
(60) Provisional application No. 62/385,662, filed on Sep. 9, 2016.
(60) Provisional application No. 62/406,982, filed on Oct. 12, 2016.

(51) Int. Cl. F04B 53/14

(52) U.S. Cl. CPC F04B 53/143; C09D 127/18; F05C 2231/00; F05C 2225/04

(57) ABSTRACT

A reciprocating piston pump may include a pump chamber, a piston seal, a monolithic partially fluorinated polymer piston with a fluid engaging end, a seating end, and a longitudinal outer piston surface extending between the fluid engaging end and the seating end. The reciprocating piston pump may further include a drive assembly coupled to the seating end of the monolithic partially fluorinated polymer piston. The drive assembly operates to reciprocate the monolithic partially fluorinated polymer piston within the pump chamber between full aspirate and full dispense positions. The piston seal forms an interface between the longitudinal outer piston surface of the piston and the pump chamber. The monolithic partially fluorinated polymer piston and the drive assembly are configured such that the piston seal interfaces with the longitudinal outer piston surface over a full stroke length of the drive assembly between the full aspirate and full dispense positions.

### CROSS-REFERENCE TO RELATED APPLICATIONS

This application claims the benefit of U.S. Provisional Application Ser. No. 62/385,662 (BCF 0006 MA), filed Sep. 9, 2016 and U.S. Provisional Application Ser. No. 62/406,982 (BCF 0006 M2), filed Oct. 12, 2016.

### BACKGROUND

The present disclosure relates to piston pumps, which may also be referred to as positive displacement pumps and, more particularly, to improvements in the design and method of manufacture of the piston utilized in the pump.

### BRIEF SUMMARY

Reciprocating piston pumps may be used to motivate fluids. Generally, fluid is drawn into a sealed chamber through one or more valves by creating a negative difference in pressure between the chamber and the fluid reservoir across the valve(s). This pressure difference may be created using a reciprocating piston to change the volume within the sealed chamber. The fluid that enters the chamber may interact with the piston. Fluid will evaporate from the piston surface(s) behind the seal, and if the fluid contains salt or other dissolved solids, crystals may form on the piston. Crystallization will cause rapid degradation of the pump seal as the piston reciprocates.

As salt builds up and adheres to the surface of the piston, either mechanically or chemically binding to the piston, it may abrade the seal, causing leakage. One alternative is to add a second seal and create a “flushed chamber” where the piston is always kept wetted which prevents the fluid from evaporating behind the primary seal, thereby never adhering to the surface, and reducing build up behind the second seal. This creates a piston pump design that is more complex and costly.

The present disclosure eliminates the need for a “flushed” pump and provides the expected performance and life expectancy from a standard piston pump configuration by using hydrophobic pistons. Specifically, properties of hydrophobic pistons in piston pumps increases the contact angle, and/or lowers the surface energy of the piston which prevents salt, or other precipitate adherence, and therefore seal degradation, thereby maintaining the desired service life of the piston pump in concentrated salt solutions.

Hydrophobicity of pistons may be obtained by using materials or processes which increase the contact angle of the liquid in contact with a surface of the piston. An increase in contact angle alters the wettability of the liquid with the surface of the piston, thereby making the surface of the piston in contact with the liquid more non-wettable or hydrophobic. That is, as the contact angle of the liquid with the piston increases, the adherence of the liquid to the piston, or the wettability decreases, thereby making the piston of the piston pump hydrophobic. Materials having a low surface energy may also be used to make the hydrophobic pistons. Specifically, materials with low surface energy prevent liquids from adhering to its surface, thereby reducing or preventing bonding of highly polar salt solutions with such materials.

Hydrophobic piston pumps may include a partially fluorinated polymer piston. In embodiments, the partially fluorinated polymer may be a chlorofluoropolymer piston. In some embodiments, the piston may be a thermoplastic chlorofluoropolymer piston. Examples of partially fluorinated polymers include, but are not limited to polychlorotrifluoroethelene (hereinafter “PCTFE”) and polytetrafluoroethelene (hereinafter “PTFE”). Examples of PCTFE that may be used to make PCTFE pistons include, but are not limited to Neoflon®, and Aclon®. Examples of PTFE that may be used to make PTFE pistons include, but are not limited to Teflon. Partially fluorinated polymers tend to arrange themselves in straight long chains, and have strong covalent bonds between the fluorine and carbon atoms. This tightly packed structure of partially fluorinated polymers reduce and/or prevent interaction of the partially fluorinated polymers with other compounds. Partially fluorinated polymer pistons may be used in any type of piston pumps.

Surfaces with low surface energies and/or high contact angles may prevent wetting of liquids on the surface, causing droplets to form which then move away from the seal area thus reducing the potential for crystals to form near the sealing area of the piston, during normal operation, and prevents adherence of any minimal amounts of formed crystals. The concepts of the present disclosure are directed towards lowering the surface energy and/or increasing the contact angle of the surfaces of pump components and thereby preventing pump seal degradation.

Accordingly, the present inventors have recognized a continuing drive to improve the performance and usable lifetime of reciprocating piston pumps by decreasing the wettability of various surfaces within the pump chamber. In accordance with one embodiment of the present disclosure, a reciprocating piston pump includes a pump chamber, a piston seal, a monolithic partially fluorinated polymer piston with a fluid engaging end, a seating end, and a longitudinal outer piston surface extending between the fluid engaging end and the seating end. The reciprocating piston pump further includes a drive assembly coupled to the seating end of the monolithic partially fluorinated polymer piston. The drive assembly operates to reciprocate the monolithic partially fluorinated polymer piston within the pump chamber between full aspirate and full dispense positions. The piston seal forms an interface between the longitudinal outer piston surface of the piston and the pump chamber. The monolithic partially fluorinated polymer piston and the drive assembly are configured such that the piston seal interfaces with the longitudinal outer piston surface over a full stroke length of the drive assembly between the full aspirate and full dispense positions.

In accordance with another embodiment of the present disclosure, a reciprocating piston pump includes a pump chamber, a piston seal a piston comprising a fluid engaging end, a seating end, and a longitudinal outer piston surface between the fluid engaging end and the seating end. The reciprocating piston pump further includes a drive assembly coupled to the seating end of the piston. The drive assembly operates to reciprocate the piston within the pump chamber between full aspirate and full dispense positions. The piston seal forms an interface between the longitudinal outer piston surface of the piston and the pump chamber. The piston and the drive assembly are configured such that the piston seal interfaces with the longitudinal outer piston surface over a full stroke length of the drive assembly between full aspirate and full dispense positions. The longitudinal outer piston surface comprises a partially fluorinated polymer coating.

In accordance with yet another embodiment of the present disclosure, a reciprocating piston pump includes a pump chamber, a piston seal, a piston comprising a fluid engaging end, a seating end, and a longitudinal outer piston surface between the fluid engaging end and the seating end. The reciprocating piston pump further includes a drive assembly coupled to the seating end of the piston. In embodiments, the drive assembly operates to reciprocate the piston within the pump chamber between full aspirate and full dispense positions, the piston seal forms an interface between the longitudinal outer piston surface of the piston and the pump chamber, and the longitudinal outer piston surface exhibits a treated surface energy and a treated contact angle along at least a portion of the longitudinal outer piston surface, and a native surface energy and a native contact angle in untreated portions of the piston. Additionally, the piston and the drive assembly are configured such that the piston seal interfaces with the longitudinal outer piston surface over a full stroke length of the drive assembly between the full aspirate and full dispense positions. Further, the treated surface energy of the piston is greater than the native surface energy of the piston, and the treated contact angle of the piston is at least about 90 degrees, and is greater than the native contact angle of the piston.

In accordance with still another embodiment of the present disclosure, a method of manufacturing a reciprocating piston pump is provided. The pump comprises a pump chamber, a piston seal, a piston comprising a fluid engaging end, a seating end, and a longitudinal outer piston surface therebetween, and a drive assembly coupled to the seating end. The drive assembly operates to reciprocate the piston within the pump chamber between full aspirate and full dispense positions. The piston seal forms an interface between the longitudinal outer piston surface of the piston and the pump chamber. The piston and the drive assembly are configured such that the piston seal interfaces with the longitudinal outer piston surface over a full stroke length of the drive assembly between the full aspirate and full dispense positions. The piston is treated with a method that comprises a piston treatment process selected such that (i) the piston exhibits a treated surface energy and a treated contact angle along at least a portion of the longitudinal outer piston surface, and a native surface energy and a native contact angle in untreated portions of the piston, (ii) the treated surface energy of the piston is greater than the native surface energy of the piston, and (iii) the treated contact angle of the piston is at least about 90 degrees.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 shows a reciprocating piston pump in a full aspirate position according to embodiments described herein; and

FIG. 2 shows the reciprocating piston pump of FIG. 1 in a full dispense position.

### DETAILED DESCRIPTION

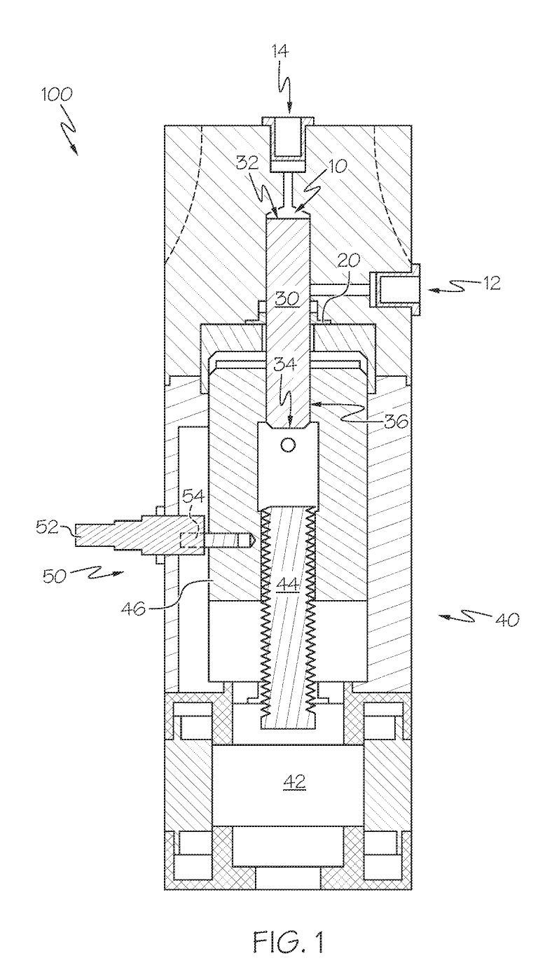

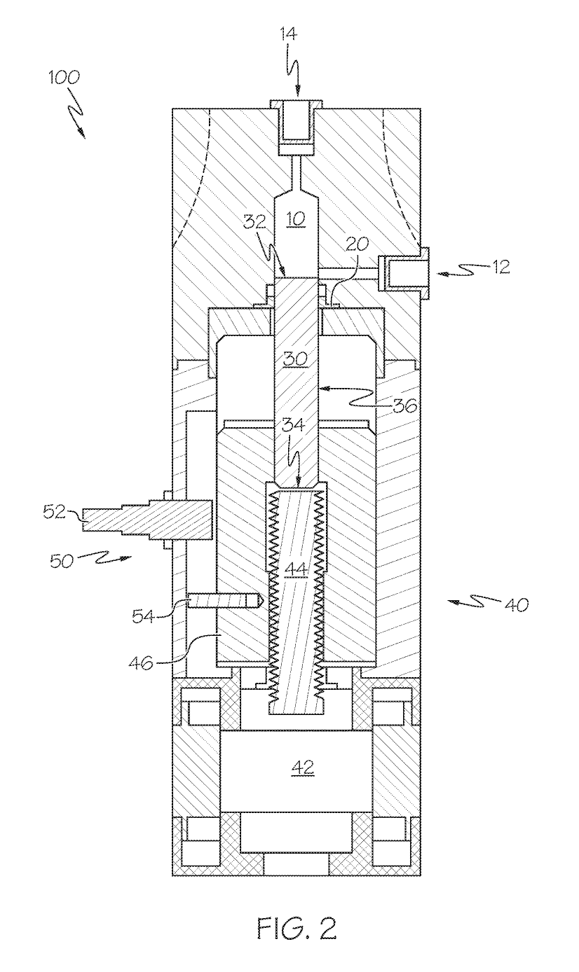

Referring initially to FIGS. 1 and 2, a reciprocating piston pump 100 is shown. The reciprocating piston pump 100 comprises a pump chamber 10, a piston seal 20, a hydrophobic piston 30 comprising a fluid engaging end 32, a seating end 34, and a longitudinal outer piston surface 36 extending between the fluid engaging end 32 and the seating end 34. The reciprocating piston pump 100 further includes a drive assembly 40 coupled to the seating end 34 of the hydrophobic piston 30.

As shown in FIGS. 1 and 2, respectively, the drive assembly 40 operates to reciprocate the hydrophobic piston 30 within the pump chamber 10 between full aspirate and full dispense positions. Additionally, the piston seal 20 forms an interface between the longitudinal outer piston surface 36 of the hydrophobic piston 30 and the pump chamber 10. Also, the hydrophobic piston 30 and the drive assembly 40 are configured such that the piston seal 20 interfaces with the longitudinal outer piston surface 36 over a full stroke length of the drive assembly 40 between the full aspirate and full dispense positions.

The reciprocating piston pump 100 may be provided with a side port 12 in the form of a one-way aspirate valve that passes fluid into the pump chamber 10 as the hydrophobic piston 30 moves away from the full aspirate position. A top port 14 might also be provided in the form of a one-way dispense valve that dispenses fluid from the pump chamber 10 as the hydrophobic piston 30 moves away from the full dispense position. However, embodiments are contemplated in which either the side port 12 or the top port 14 are fluidly coupled with a three-way valve such that either might act as both inlet and outlet to motivate fluid through a system. In such an embodiment, the side port 12 or the top port 14 would perform as a two-way port, allowing fluid to flow in and out of the pump chamber 10 with a three-way valve positioned appropriately to direct the flow of liquid through the system. In some embodiments, a three-way valve may be coupled to both the side port 12 and the top port 14 but positioned such that only one of the side port 12 or the top port 14 is acting as the single port to the pump chamber 10 at one time. In some embodiments, the side port 12 or the top port 14 may be used only to prime the pump chamber 10 before operations or to otherwise fill the pump chamber 10.

The drive assembly 40 may comprise a motor 42, a piston driver 44, and a driver-to-piston coupling device 46 for coupling the hydrophobic piston 30 to the piston driver 44. The motor 42 is configured to actuate the piston driver 44 and the piston driver 44 is coupled to the hydrophobic piston 30 by the driver-to-piston coupling device 46 such that the motor 42 reciprocates the hydrophobic piston 30 between the full aspirate and full dispense positions. The piston driver 44 may be a motor-driven lead screw and the driver-to-piston coupling device 46 may be a drive nut. In which case, the motor-driven lead screw and the drive nut may be coaxial with the hydrophobic piston 30. The motor-driven lead screw may be rotatably fixed to the motor 42 and the drive nut may be threadably coupled to the motor-driven lead screw such that actuation of the motor 42 rotates the motor-driven lead screw to longitudinally reciprocate the drive nut. The motor 42 may comprise a servo motor or a stepper motor and the drive nut and lead screw may be fabricated from a metal, a polymer or may be fabricated from the same material as the hydrophobic piston 30.

As is described in detail below, one or more components of the reciprocating piston pump 100 may be fabricated from a partially fluorinated polymer, such as, for example polyclorotrifluorethylene (PCTFE) or polytetrafluoroethylene (PTFE). Partially fluorinated polymers such as PCTFE and PTFE have excellent chemical resistance, exhibit zero-moisture absorption, and are non-wetting. Additionally, such partially fluorinated polymers are resistant to attack by most chemicals and oxidizing agents. Due to these reasons, the partially fluorinated polymer piston minimizes or eliminates deposits or buildups within the pump that may occur while pumping fluids with a high salt concentration. Additionally, the use of partially fluorinated polymer pistons also minimizes degradation of seals and the seal jackets. In example embodiments, the piston may be made of multiple materials, with at least one material being a partially fluorinated polymer such as PCTFE or PTFE. In some embodiments of the reciprocating piston pump 100, the hydrophobic piston 30 comprises at least about 0.05%, by weight, partially fluorinated polymer.

It is contemplated that, while the wettability of a partially fluorinated polymer hydrophobic piston is partially dependent upon the surface energy of the piston and the surface energy of the liquid within a pump chamber the surface energy of such a piston can be determined in isolation, given a constant set of physical properties of the piston (e.g., volume, temperature, etc.). Similarly, the wettability of a piston might vary depending on its use. For example, if a piston is used to pump fluids with various surface energies at various temperatures, this will result in distinct wettability characteristics for each set of pumping conditions, as would be the case when pumping sodium hydroxide, sodium chloride, or other fluids having a high concentration of salts. It is contemplated that pistons with one or more of the composition, coating, and/or surface treatments described herein will have higher contact angles and surface energies, resulting in lower wettability, than conventional pistons. For example, some embodiments of the reciprocating piston pump 100 may be configured such that the contact angle of the partially fluorinated polymer with water in the pump chamber is at least about 90 degrees. As an additional non-limiting example, in some embodiments of the reciprocating piston pump 100, it may be advantageous for the reciprocating piston pump 100 to be configured such that the contact angle of the partially fluorinated polymer with water in the pump chamber is at least about 125 degrees.

In particular embodiments, the longitudinal outer piston surface 36 may comprise a partially fluorinated polymer coating. In such embodiments, the hydrophobic piston 30 may comprise an underbody, which may be polymeric or non-polymeric. For example, and not by way of limitation, it is contemplated that the partially fluorinated polymer may be PCTFE or PTFE and the underbody may comprise any rigid material such as, aluminum, stainless steel, PEEK, polypropylene, polystyrene, polyimides, polyester, polycarbonates, silicon, glass, ethylene, urethanes, ceramic zirconia tetragonal zirconia polycrystal (TZP) or another ceramic, titanium, cobalt chrome, Hastelloy®, Elgiloy®, gems such as sapphires and rubies, or combinations thereof.

In embodiments where the hydrophobic piston 30 comprises an underbody coated with a partially fluorinated polymer coating, nitride coating, or a silane coating, it is contemplated that the coating may be a minimum of 10 microns thick. Additionally, the hydrophobic piston 30 may comprise at least about 0.05%, by weight, partially fluorinated polymer.

In yet other embodiments of the reciprocating piston pump 100, the hydrophobic piston 30 comprises a monolithic piston body composed of a partially fluorinated polymer, such as, for example, PCTFE or PTFE. Reference herein to a monolithic partially fluorinated polymer piston covers pistons where the substantial entirety of the piston body is formed from a partially fluorinated polymer. For example, while it is contemplated that all parts, features, and components of the piston may be formed from a partially fluorinated polymer, it is also contemplated that other materials may be presented as part of the piston. For example, in one embodiment, a monolithic partially fluorinated polymer piston may be coated with a material that further enhances its performance or durability. For example, a monolithic piston may be coated with a nitride, a silane, or another partially fluorinated polymer. It is further contemplated that the piston, if coated, or treated in some other way, may be coated or treated by any process that would increase the surface energy or the contact angle or decrease the wettability and/or the friction between the piston and the seal such as, for example, a graphite coating or a Teflon coating.

It is contemplated that a treated portion of the hydrophobic piston 30 may be treated using a surface modification process selected from a plasma treatment, corona discharge, photolysis, ion beam deposition, or combinations thereof. Additional contemplated treatment processes include, but are not limited to, a nitride coating process, a silane coating process, a partially fluorinated polymer coating process, a fluorinated polymer coating process, a fluorinated polymer filling process, a PCTFE coating process, a PTFE coating process, or combinations thereof. In many cases, untreated portions of the hydrophobic piston 30 will lie beneath the longitudinal outer piston surface 36. The aforementioned surface treatment processes tend to increase the liquid contact angle at the surface of the piston, reduce the surface energy of the surface of the piston, or both, which results in a more hydrophobic piston. In some embodiments of the reciprocating piston pump 100, the surface modification of the surface modification process extends to a depth of at least 10 microns.

In some embodiments of the reciprocating piston pump 100, the hydrophobic piston 30 comprises a treated portion treated with a surface treatment process and an untreated portion, and the treated portion of the hydrophobic piston 30 comprises a treated surface energy that is at least 90 degrees.

In some embodiments, select portions of a monolithic partially fluorinated polymer piston, like the seating end 34 or the fluid engaging end 32 may be reinforced with a material that is different from the partially fluorinated polymer forming the rest of the piston. Alternatively, in some embodiments, various components of the reciprocating piston pump 100 may have similar compositions. For example, the driver-to-piston coupling device 46 and the hydrophobic piston 30 may have the same composition to enable the hydrophobic piston 30 to be press fit with the driver-to-piston coupling device and/or the seating end 34 of the hydrophobic piston 30 may be chamfered to enable the hydrophobic piston 30 to be press fit with the driver-to-piston coupling device 46. In some embodiments, the driver-to-piston coupling device 46 may comprise polyethylene (PE), PCTFE, or PTFE.

In some embodiments, the reciprocating piston pump 100 will comprise a positive displacement pump. Positive displacement pumps may include hydrophobic pistons that are made of partially fluorinated polymer pistons or surface modified hydrophobic pistons. For example, piston pumps such as lift pumps, force pumps, axial piston pumps, rotary piston pumps, radial piston pumps, direct-acting pumps, power pumps, double action piston pumps, or differential piston pumps may include the hydrophobic piston 30. In some embodiments, plunger pumps, and diaphragm pumps may also include the hydrophobic piston 30.

It is contemplated that the reciprocating piston pump 100 may comprise various operational support systems, such as, for example, a sensor system 50 comprising a contact sensor 52 and a pin 54 for sensing the position of the hydrophobic piston 30. The sensor system 50 may be communicatively or electronically coupled to one or more systems such as a control system or motor controller for operating the reciprocating piston pump 100.

In some embodiments of the reciprocating piston pump 100, the hydrophobic piston 30 may comprise metals or alloys such as stainless steel, titanium, cobalt chrome, Hastelloy, Elgiloy, and gems such as sapphires and rubies. The hydrophobic piston 30 may also include acrylic material, PEEK, ceramic zirconia TZP, or a combination thereof. Hydrophobic pistons may also be obtained by surface modifications processes, where contact angles may be increased, and/or surface energy may be decreased to obtain hydrophobic pistons such as hydrophobic piston 30.

Examples of surface modification processes include, but are not limited to plasma treatments, corona discharge, photolysis, ion beam deposition, nitride coatings, silane coatings, fluorinated polymer coatings, fluorinated polymer fillers, and the like that may alter the contact angles and surface energy of a variety of materials. Exemplary materials that may be modified by surface modification include, but are not limited to acrylics, aluminum, stainless steel, ceramics, polypropylene, polystyrene, polyimides, polyester, polycarbonates, silicon, glass, ethylene, urethanes, PEEK, and the like. Therefore, such materials, on being subject to surface modification processes may increase the contact angle of the liquid with the surface of the piston material, or reduce the surface energy of the surface of the piston material resulting in the hydrophobic piston.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

For the purposes of describing and defining the present invention it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A reciprocating piston pump comprising:
a pump chamber;
a piston seal;
a monolithic partially fluorinated polymer piston comprising a fluid engaging end, a seating end, and a longitudinal outer piston surface extending between the fluid engaging end and the seating end; and
a drive assembly coupled to the seating end of the monolithic partially fluorinated polymer piston; wherein
the drive assembly operates to reciprocate the monolithic partially fluorinated polymer piston within the pump chamber between full aspirate and full dispense positions,
the piston seal forms an interface between the longitudinal outer piston surface of the piston and the pump chamber, and
the monolithic partially fluorinated polymer piston and the drive assembly are configured such that the piston seal interfaces with the longitudinal outer piston surface over a full stroke length of the drive assembly between the full aspirate and full dispense positions.

2. The reciprocating piston pump of claim 1, wherein the monolithic partially fluorinated polymer piston comprises polychlorotrifluoroethylene (PCTFE).

3. The reciprocating piston pump of claim 1 wherein the monolithic partially fluorinated polymer piston comprises polytetrafluoroethylene (PTFE).

4. The reciprocating piston pump of claim 1, wherein the contact angle of the partially fluorinated polymer with water in the pump chamber is at least about 90 degrees.

5. The reciprocating piston pump of claim 1, wherein the contact angle of the partially fluorinated polymer with water in the pump chamber is at least about 125 degrees.

6. The reciprocating piston pump of claim 1, wherein:
the drive assembly comprises a motor, a piston driver, and a driver-to-piston coupling device for coupling the monolithic partially fluorinated polymer piston to the piston driver, and
the motor is configured to actuate the piston driver and the piston driver is coupled to the monolithic partially fluorinated polymer piston by the driver-to-piston coupling device such that the motor reciprocates the monolithic partially fluorinated polymer piston between the full aspirate and full dispense positions.

7. The reciprocating piston pump of claim 6, wherein the seating end of the monolithic partially fluorinated polymer piston is press fit with the driver-to-piston coupling device.

8. The reciprocating piston pump of claim 7, wherein the seating end of the monolithic partially fluorinated polymer piston is chamfered to enable the piston to be press fit with the driver-to-piston coupling device.

9. The reciprocating piston pump of claim 6, wherein the driver-to-piston coupling device and the monolithic partially fluorinated polymer piston have the same composition and are press fit together.

10. The reciprocating piston pump of claim 1, wherein the monolithic partially fluorinated polymer piston comprises a treated portion treated with a surface treatment process and an untreated portion, and the treated portion of the monolithic partially fluorinated polymer piston comprises a treated surface energy that is at least 90 degrees.

11. A reciprocating piston pump comprising:
a pump chamber;
a piston seal;
a piston comprising a fluid engaging end, a seating end, and a longitudinal outer piston surface between the fluid engaging end and the seating end; and
a drive assembly coupled to the seating end of the piston; wherein
the drive assembly operates to reciprocate the piston within the pump chamber between full aspirate and full dispense positions,
the piston seal forms an interface between the longitudinal outer piston surface of the piston and the pump chamber,
the piston and the drive assembly are configured such that the piston seal interfaces with the longitudinal outer piston surface over a full stroke length of the drive assembly between full aspirate and full dispense positions, and
the longitudinal outer piston surface comprises a partially fluorinated polymer coating.

12. The reciprocating piston pump of claim 11, wherein the piston comprises an underbody that is non-polymeric.

13. The reciprocating piston pump of claim 11, wherein the partially fluorinated polymer is polychlorotrifluoroethylene (PCTFE).

14. The reciprocating piston pump of claim 11, wherein the partially fluorinated polymer is polytetrafluoroethylene (PTFE).

15. The reciprocating piston pump of claim 10, wherein the coating is at least 10 microns thick.

16. A reciprocating piston pump comprising:
a pump chamber;
a piston seal;
a piston comprising a fluid engaging end, a seating end, and a longitudinal outer piston surface between the fluid engaging end and the seating end; and
a drive assembly coupled to the seating end of the piston; wherein
the drive assembly operates to reciprocate the piston within the pump chamber between full aspirate and full dispense positions,
the piston seal forms an interface between the longitudinal outer piston surface of the piston and the pump chamber, and
the longitudinal outer piston surface exhibits a treated surface energy and a treated contact angle along at least a portion of the longitudinal outer piston surface, and a native surface energy and a native contact angle in untreated portions of the piston,
the piston and the drive assembly are configured such that the piston seal interfaces with the longitudinal outer piston surface over a full stroke length of the drive assembly between the full aspirate and full dispense positions,
the treated surface energy of the piston is greater than the native surface energy of the piston, and
the treated contact angle of the piston is at least about 90 degrees, and is greater than the native contact angle of the piston.

17. The reciprocating piston pump of claim 16, wherein the treated portion of the piston is treated using a surface modification process selected from a plasma treatment, corona discharge, photolysis, ion beam deposition, or combinations thereof.

18. The reciprocating piston pump of claim 16, wherein the surface modification of the surface modification process extends to a depth of at least 10 microns.

19. A method of manufacturing a reciprocating piston pump comprising:
a pump chamber;
a piston seal;
a piston comprising a fluid engaging end, a seating end, and a longitudinal outer piston surface therebetween; and
a drive assembly coupled to the seating end; wherein
the drive assembly operates to reciprocate the piston within the pump chamber between full aspirate and full dispense positions,
the piston seal forms an interface between the longitudinal outer piston surface of the piston and the pump chamber,
the piston and the drive assembly are configured such that the piston seal interfaces with the longitudinal outer piston surface over a full stroke length of the drive assembly between the full aspirate and full dispense positions, and
the piston is treated with a method that comprises a piston treatment process selected such that
the piston exhibits a treated surface energy and a treated contact angle along at least a portion of the longitudinal outer piston surface, and a native surface energy and a native contact angle in untreated portions of the piston,
the treated surface energy of the piston is greater than the native surface energy of the piston, and
the treated contact angle of the piston is at least about 90 degrees.

20. The method of claim 19, wherein the piston treatment process comprises a surface modification process selected from a plasma treatment, corona discharge, photolysis, ion beam deposition, or combinations thereof.

21. The method of claim 19, wherein the piston treatment process comprises a nitride coating process, a silane coating process, a partially fluorinated polymer coating process, a fluorinated polymer coating process, a fluorinated polymer filling process, or combinations thereof.

22. The method of claim 19, wherein the piston treatment process comprises a polychlorotrifluoroethylene coating process or a polytetrafluoroethylene coating process.
